(19) United States
(12) Patent Application Publication
(10) Pub. No.: US 2011/0231260 A1
(43) Pub. Date: Sep. 22, 2011

(54) METHOD FOR PROVIDING AN ONLINE VIDEO ADVERTISING PLATFORM AND MARKETPLACE

(76) Inventor: Kenneth Kevin Price, Ashburn, VA (US)

(21) Appl. No.: 12/725,514

(22) Filed: Mar. 17, 2010

(51) Int. Cl. G06Q 30/00; G06F 3/14; G06F 17/30; G06F 3/048

(52) U.S. Cl. 705/14.61; 705/14.73; 705/14.72; 715/205; 707/812; 707/758; 715/719; 707/E17.005; 707/E17.009; 707/E17.014

(57) ABSTRACT

An online video advertising platform and marketplace. The present invention enables sellers to enhance the way they market products by providing them with a platform that uses location, images, product information, and Internet video. Because images and text are static and videos are dynamic, a seller can better represent their product and receive a better price and quicker sale as a result of the dynamic presentation. The marketplace uses both a database and “cloud computing” file storage system. So when a new user is created, there is both an entry in the database, and file structure with the username or other unique identifier in the file system. The database then stores pointers to these files. All listings are tied to a central product (listing) Id (PID). Videos can be searched for by both video and product related metrics. Videos file themselves are tagged with product metadata.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to an interactive communications system. More specifically, the present invention relates to an auction system allowing a plurality of remote bidders to participate in an auction on a real-time basis.

### BACKGROUND OF THE INVENTION

Auction is a centuries old process that, in the past decade, has seen a resurgence due to the Internet. The development of the Internet and online auctions has create new businesses, business models and continues to develop. The current state of the art is to provide buyers and sellers with static product displays using text and pictures. While a static display may be sufficient and applicable to many products, a dynamic display, including a video presentation of the product is more desirable.

The continued development of home video systems including cell phones, cameras, dedicated video devices, home video recorders, and computer video camera's has provided almost ubiquitous ability for a person to create a product demonstration video of a product and sell it online, via any number of auction sites on the Internet.

The prior art has yet to create an efficient means for enabling a person to easily and efficiently create a video for the auction of a product or service. What is needed is a method for creation and distribution of a video description of a good or service for distribution to an auction site.

When a potential buyer goes into a store, the first thing the buyer does is look at the items on the shelf, which is the equivalent of seeing images on a static auction website. Then the buyer reads the label and box, which is the equivalent of seeing text on a static auction website. If the buyer is really interested, they buyer typically asks a salesperson for more information, feedback, etc. This is where the product demonstration video comes in to play. The product demonstration video is a virtual salesperson that can show, explain, and talk about the product or service.

Buyers are becoming increasingly reliant on real time product reviews and validations before making product choices. Using product demonstration video to review and market goods is the most effective way to present prospective buyers with this transaction enabling information.

The challenge is that with billions of products and services in the world, no single entity could produce all those videos. Therefore, what is needed is a marketplace built to serve a community of independent sellers who realize the strength of video as a marketing tool.

Ten to fifteen years ago, images and pictures fueled by digital photography were all the rage. Today they are commonplace and most e-commerce sites are still just images and text. What is needed is a means to change the reliance on digital photography because video enabled e-commerce is the next logical step in the evolution of the web.

### SUMMARY OF THE INVENTION

The method of the present invention is an online video advertising platform and marketplace. The present invention teaches a method for promoting a product or service using video. The present invention enables sellers to enhance the way they market products by providing them with a platform that uses location, images, product information, and Internet video. Because images and text are static and videos are dynamic, a seller can better represent their product and receive a better price and quicker sale as a result of the dynamic presentation.

The present invention is a marketplace built to serve a community of independent sellers who realize the strength of video as a marketing tool. An independent seller could be: an individual; a local merchant; an affiliate marketer; an inventor of a new product; a large retailer or manufacturer; or anyone who wants to sell something via video

For buyers and shoppers the present invention provides: a unique shopping experience enhanced by video; a promise that every listing is transactional—it's something that can be purchased; and a community where buyers can comment and rate both products and videos.

For sellers the present invention provides: a way to show off a seller's products, personality, and expertise; means for a seller to interact and engage customers as never before; means for a seller to build their image, brand, and expertise with video. Additionally, the present invention teaches a means for helping individual sellers reach a larger audience; helping affiliate marketers grow their business; and helping local merchants stand out from their competition.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a screen shot of an embodiment of the present invention illustrating a Search Engine Optimized (SEO) Video listing layout;

FIG. 2 is a screen shot of an embodiment of the present invention illustrating a product listing;

FIG. 3 is a screen shot of an embodiment of the present invention illustrating a listing information panel;

FIG. 4 is a flow chart illustrating the listing process;

FIG. 5 is a flow chart illustrating the URL shortening and obfuscation;

FIG. 6 is a flow chart illustrating the Transaction URL shortening and obfuscation;

FIG. 7 is a flow chart illustrating the increasing traffic application;

FIG. 8 is a screen shot of an embodiment of the present invention image selection panel;

FIG. 9 is a flow chart illustrating the data entry system (DES) of the present invention;

FIG. 10 is a flow chart illustrating the market place created by the present invention;

FIG. 11 illustrates the entity relationships;

FIG. 12 is a flow chart illustrating the Flexible Linking enablement of the present invention;

FIG. 13 is a meta-data display from a product listing page created by the present invention;

FIG. 14 is an illustrative website page of the DES video search results;

FIG. 15 is an illustrative website page of the DES video search results with video selected;

FIG. 16 is an illustrative website page of the DES create listing page;

FIG. 17 is an illustrative website page of the traffic increasing default settings;

FIG. 18 is an illustrative website page of the traffic increasing list of campaigns;

FIG. 19 is an illustrative website page of multiple accounts associated with increased traffic campaigns;

FIGS. 20-21 are illustrative website pages of a GOOGLE ADWORDS seller campaign;

FIG. 22 is an illustrative website page of traffic increasing list of sellers;

FIG. 23 is an illustrative website page of a meta-data tagged to video file (FLV) based on listing information;

FIG. 24 is an illustrative website page of a video widget supporting multiple products and payment information;

FIG. 25 is a flow chart illustrating the video player process;

FIG. 26 is a flow chart illustrating the video player workflow;

FIG. 27 is a flow chart illustrating the video player payment workflow;

FIG. 28 is a flow chart illustrating the video player submission request workflow;

FIG. 29 is a flow chart illustrating the multiple video player coupon processes; and

FIG. 30 is a flow chart illustrating the video asset page workflow.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

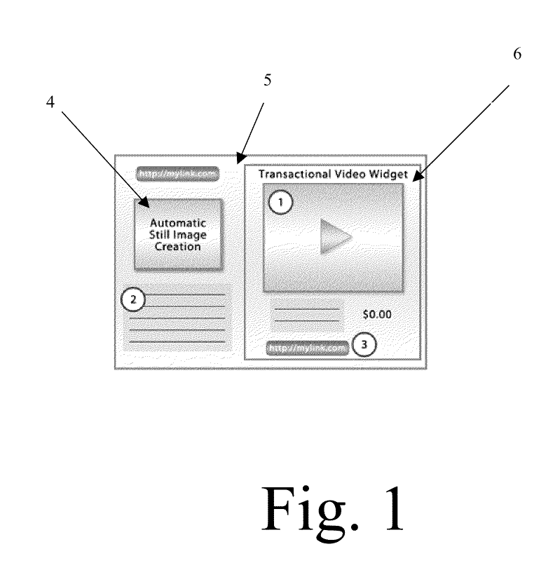

Now referring to the Figures, the embodiment of the present invention is illustrated. In FIG. 1, the market place created by the present invention is defined by a seller's video 1, product link 2 or personal link 3. When displayed in an exemplary search engine optimization (SEO) video listing, a still image 4 and product information 2 are displayed with a link 3 in a first defined space 5 of the Video listing. In a second defined space defining a transaction video widget 6, the video 1, link 3, and additional detailed information is displayed. The link 3, is tied to the video so that wherever the video is displayed, the link is correspondingly displayed as well. For example, if the Video Widget was embedded into email, a social media website, an ad campaign or other video website, the link 3 and video 1 would both travel together and be displayed to another user.

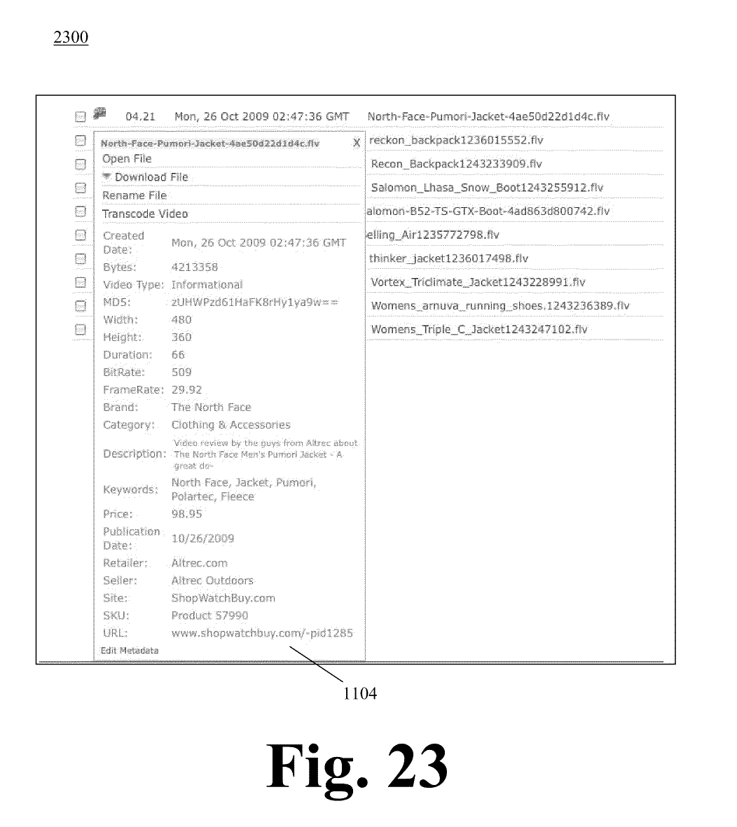

The present invention teaches a video enabled e-commerce marketplace where every listing 1101 has a video 1103 in a transaction enabled video player. All listings are tied to a central product (listing) Id (PID) 1102 and have transaction links 1105. Videos can be searched for by both video and product related metrics. Common video metrics are most viewed, length, etc. Product video metrics are brand, location, condition, and price. Video files themselves 2300 (i.e. the FLV video file) are tagged with product metadata 1104 as shown in FIG. 23.

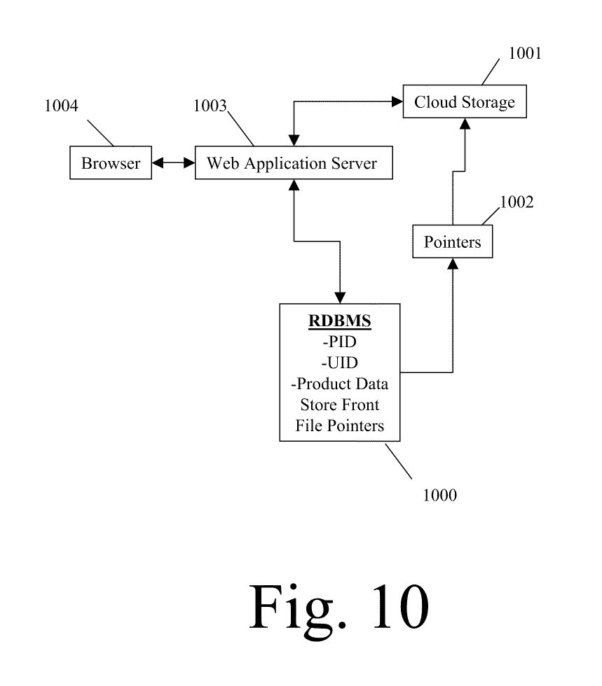

The marketplace, as shown in FIG. 10, is comprised of a browser 1004 that enables a user, buyer, or seller, to access the web application server 1003, which, in turn, can access a database 1000 and cloud computing file storage system 1001. The marketplace uses both a database 1000 and “cloud computing” 1001 file storage system. So when a new user is created, there is both an entry in the database 1000, and file structure 1001 with the username or other unique identifier in the file system. The files are stored in the following convention: username/folder/file_namefiles are then accessible via an http call to a unique URL such as: http://services.video.the marketplace service.com/laprima/video/my_video.flv The database then stores pointers 1002 to these files.

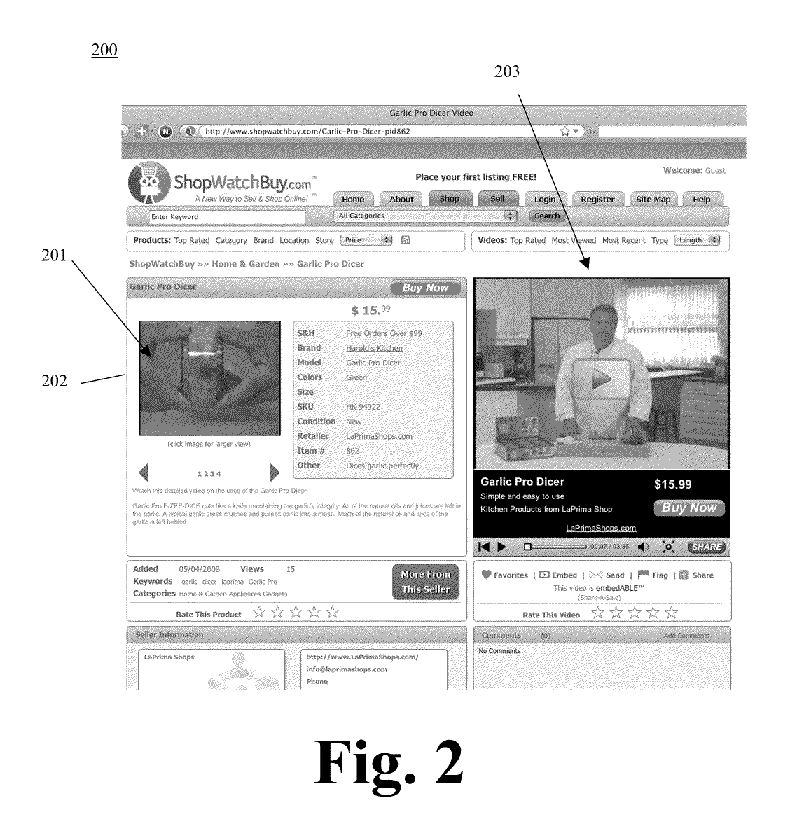

Now referring to FIG. 2, the Page Layout comprising Images and Meta-data on the left, with the video on the right is shown. Web pages are typically viewed from left to right, top to bottom—sometimes referred to as an “F” pattern. Most video sites place the subject video either in the center or top left quadrant. Other information such as picture and text are secondary in nature to support the video. The layout of the present invention maximizes the “F” pattern in a format that is more aligned with how people actually take in formation. As shown in FIG. 2 images 201 are shown first in the top left 202 of the page 200. Text 203 is second and shown in the left half of page, right & below image. The Video 203 is shown third on the right half of page.

In this way the video supports the images and text (metadata) for the listing. A user can quickly see what the product is by viewing the image, scan the info (Metadata and/or description) then watch the video if they are truly interested.

The video player (also referred to as the “video widget”) uses databases access for information and pointers to relevant files in a cloud computing file storage platform to create a dynamic “video widget” for each listing. Each instance of the video player is tied back to a unique listing/product Identification number or PID in the database. Once a listing is created, the PID never changes. This is import as it allows flexibility for updating.

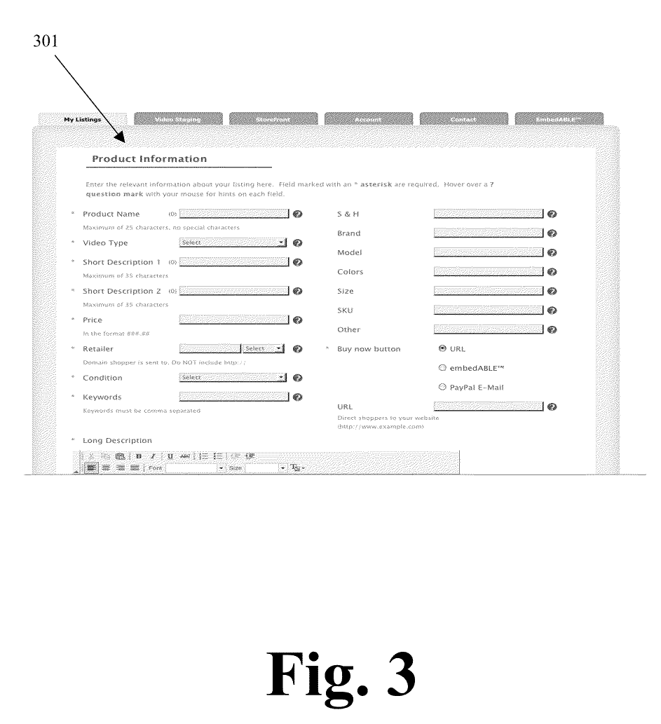

The video widget calls the database based on the PID and pulls any and all information about the listing into the player. The information includes, but is not limited to: the video file; the transactional link; title; price; and short descriptions as shown in FIG. 3 under Product Information 301.

Since the PID is also tied back to a given Seller, the player can also pull information related to the Seller. Including but not limited to: seller name; other listings (i.e. “More from this Seller”); and location and map integration.

The player can also link to extraneous other files associated with the listing such as product information. For example, the seller uploads product information PDF document with the listing. If such a document exists, the player will display a small icon for the user to click on and download the document.

The player retrieves a list of other products from the seller. When a different product is selected the video and/or other information is loaded into the player for viewing.

The player has link(s) via a button (“Buy Now”) and/or separate text that the user can click on to buy, donate, save, etc. This transactional link serves as a link to a web page an payment email (i.e. PayPal) or download (such as a coupon).

The transactional link button can be different (i.e. different color & text) based on user preference and/or the listing type. Including, but not limited to: Buy Now, for an item for Sale; Donate Now, to donate to a Charity; Save Now, for a coupon via a website, download or code; Download Now, to download a piece of software, Try Now, for a free trial for a product, service or software; Custom Text, to create a custom button text for a call to Action.

Instead of a button/link to download a coupon (as described above) the player would display a coupon code at the END of the video play to entice the user to watch the entire video. This could be a static code from an uploaded image (i.e. the widget “plays” the image after the video file completes) or it can be a dynamic code that is generated and displayed in the player at the end of the video.

If changes are made to the listing on the marketplace database anyplace that the video is shared (i.e. Facebook, other website, blog, etc.) is updated because each player instance is tied back to the listing PID. This could be the Title, Price, Transactional link—even the video itself.

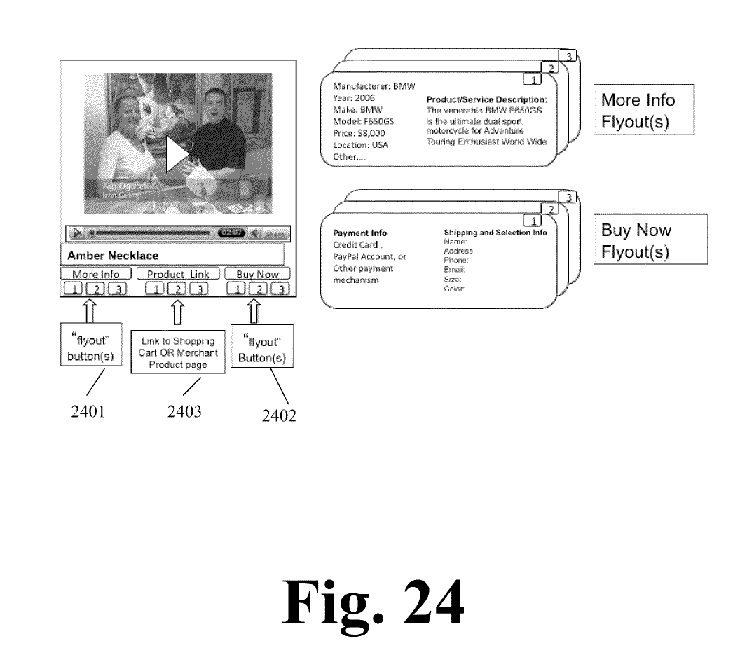

The widget could also support multiple videos for multiple listings, with multiple “product links” 2403, “more info” 2401 and multiple “Buy Now” 2402 links as shown in FIG. 24.

Instead of being re-directed to another page, the buy now button could open a credit card and/or PayPal form within the player itself thereby allowing the user to complete the purchase on the page where the video is embedded.

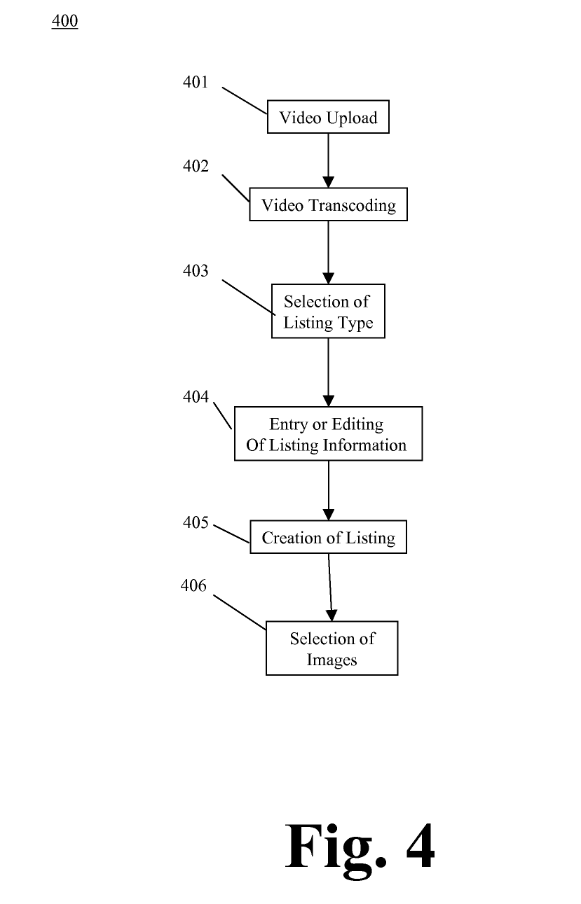

Now referring to FIG. 4, the listing process 400 starts with a video upload 401. First videos are put in a queue waiting to be transcoded 402. They can come from a variety of sources: Uploaded from user's computer, brought in from a video-sharing site such as YOUTUBE, and recorded directly from users “web cam”. Once a video is transcoded 402, the user selects a listing type 403 which determines the meta-data model and or transaction buttons that will be associated with the listing and video.

The User selects a Listing Type: Product, Car, Real Estate, Charity, etc. or custom. Each Listing Type has a unique meta-data model to describe and tag the video. For example, Cars have fields like year, make & model. Real Estate has location, bedrooms and bathrooms. A custom type allows the user to define their own meta-data.

Listing types may also have different inherent functionality on the site and the video player. For example a Charity listing may default to a “donate now” button. Next, the user enters meta-data about the listing video. There is a 25-character title and two 35 character “short descriptions” that match the GOOGLE ADWORDS format. These are used for: a Display in Video Player and Auto Creation of GOOGLE ADWORDS ads and/or other ads in various online adverting systems.

The User Defines a “transactional Button” such as: Buy Now, Donate Now, Save Now, Custom Text, etc. The User defines a “transactional link” such as: URL, flexible linking enablement “Default” URL, or PayPal email. Next a User selects both video type (Action, Fun, How To) and product category (Auto, Books, Charity). Upon Submission, the video file is renamed to match the listing title and moved from the /transcoded folder to the /video folder in the file system. The video file is also injected with Metadata based on the listing info (price, brand, etc.)

A user can next edit, delete, view or “create a listing” from it in an edit listing step 404. When the listing is created in step 405 the video file will be renamed to match the name of the listing and tagged with meta-data specific to the listing itself.

Once a listing is created in step 405, the images are either extracted from video, uploaded from local computer or import from another URL in step 406. Images extraction can be re-processed based on user input (i.e. pull 1 frame every 5, 10, 15 seconds, etc.). Inactive images are stored and associated with the listing. Active images are displayed on the marketplace. Images are automatically renamed based on the listing title for search engine optimization. Active images can be dragged and dropped to change the order in which they appear on the front end. Videos usually have a “thumbnail” image associate with them. The first active image, which can be change as described above, automatically becomes the thumbnail image for that video. Images can be dragged and dropped into a trashcan for permanent deletion.

Manufacturers and Retailers often cannot produce a video for each and every product. One solution is “user generated” videos. However, these companies are very brand conscious and concerned about how user generated videos represent their brand. Video approval workflow solves this problem. First, the Seller has an account on the marketplace with a “Submit Video” button. There's also a list of products the Seller needs videos for (optional). Next, the user (who also has an account) clicks submit video and uploads a video and product data (optional). The video is put in that seller's “user-submitted” queue. The Seller can review the video and/or product data and reject, approve or edit as needed. If approved, the Seller then “creates listing” from the user's video.

Sellers can pay users for there submissions. The Seller sets how much they are willing to pay for an approved video. After approval, but before creating the listing, the Sellers pays the user for the product video payment is via electronic means such as PayPal. The marketplace may take a fixed fee or percentage of the transaction.

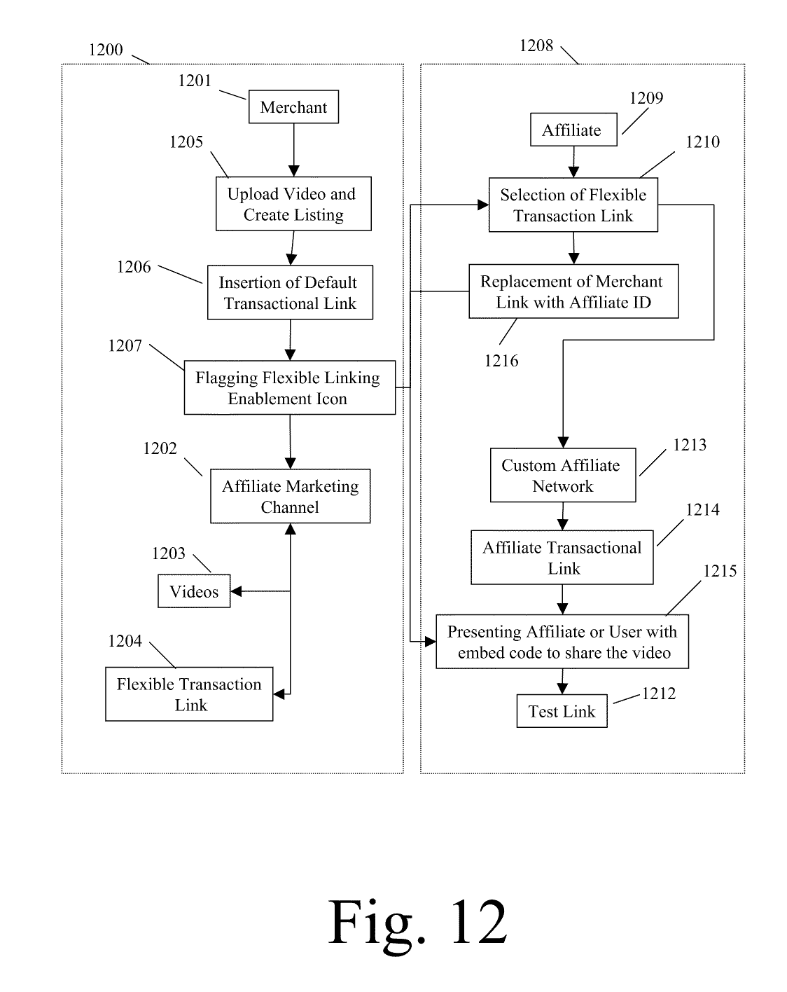

Flexible linking enablement, as shown in FIG. 12 is a way for merchants 1201 with an affiliate marketing channel 1202 to monetize their videos 1203 via the affiliate marketing channel 1202. It allows the merchant (seller) 1201 to have a flexible transactional link 1204 for the player that can be substituted by a given affiliate. It works with any affiliate network, but has pre-built integration for some. In this use case, the Merchant is the video “uploader” and the affiliate the primary “sharer” of the video.

In the Merchant Process 1200, first a user 1201 uploads a video and creates a listing 1205. Next a user inserts a “Default” transactional link 1206. This default link is used whenever a user clicks “Buy Now” (or other text/button) from the marketplace. The “Default” transactional link is called the flexible linking enablement link and can be a predefined or custom affiliate network link. A predefined format my be something like: http://network_link.com?user=1234 Flexible linking enablement listing are flagged with a visual cue so the user knows it is available 1207. Via the control panel, the Merchant 1201 can select which listings have been embedded, the number of plays, clicks, the specific transactional link, and other information.

The Affiliate Process 1208 is enabled by the control panel, the affiliate 1209 enters his unique identifier for a specific network (i.e. 9999). The affiliate 1209 sees the flexible linking enablement icon for a listing they want to use and clicks on it 1210. The flexible linking enablement page presents them with a size and/or other customization selection (color, button, etc.) 1211. Upon submission, the appropriate portion of the Merchant Link is replaced by the Affiliates Id 1212 so the transactional link now becomes: http://network_link.com?user=9999 If it not a pre-defined or “custom” affiliate network link 1213, then the affiliate would put in the complete URL needed to replace and become the transactional link 1214. This is why it works with ANY affiliate network. The Affiliate is presented with the embed code to share the video 1215, and a “test link” to test the actual link behind the button to make sure it works 1216.

Besides Affiliate Marketing, flexible linking enablement allows for the substitution of ANY link for the transactional link. For example a Manufacturer posts a video with the default link back to the manufacture's website or a product PDF file. In this case the “Affiliate Network” would be “Other.” Then when a distributor or retailer grabs the video they insert their transactional link for the buy now or other transactional button. In this scenario it's not just a substring, but also the entire URL that is replaced.

When an Internet user finds an flexible linking enablement video placed on a 3^{rd} party site (someplace other than the marketplace) and would like to use the video, but substitute his own transactional link for the “Buy Now” button. There are two implementations. A link in the player takes the user back to the marketplace flexible linking enablement page for that product or a link in the player opens a window in the player itself and prompts the Internet user for a login to the marketplace. The player makes a web service call back to marketplace, and based on the Internet user credentials, gets the proper flexible linking enablement code and displays it back to the user. If the flexible linking enablement network is “other”, the user is prompted for a URL entry. This way the user gets the code without ever leaving the site they are on.

Because the flexible linking enablement link id and product id and data are stored in the database, the present invention can provide the both the Merchant/Uploader and Affiliate/Sharer information about the flexible linking enablement video such as: flexible linking enablement id, flexible linking enablement Link (the substituted link), embed code, Number of Views, Number of Plays, Number of “Buy Now” Clicks, Location (URL) where video is embedded

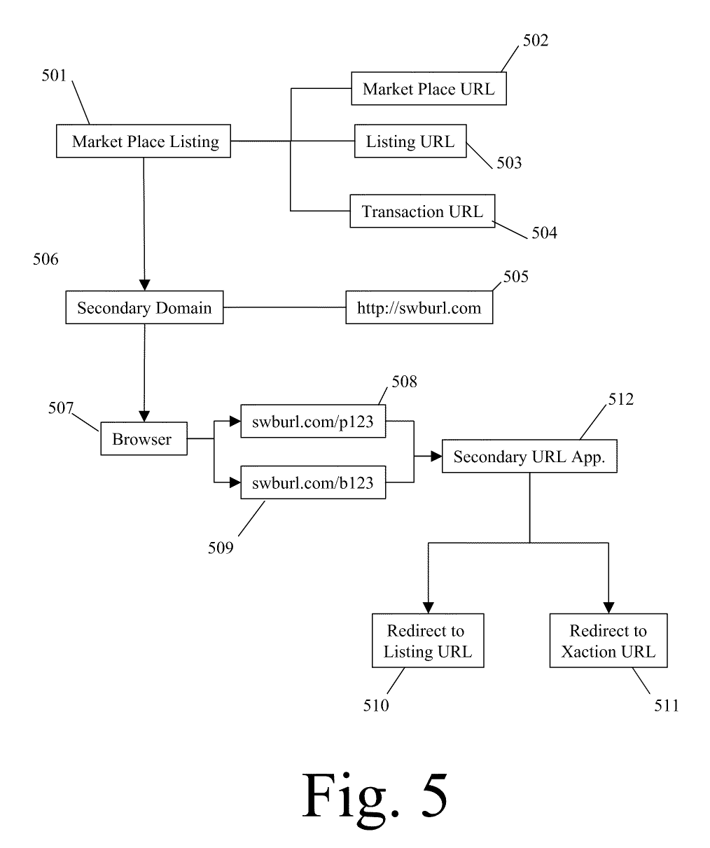

Now referring to FIG. 5, URL Obfuscation/Abstraction is shown. Every listing has a page 502 on the marketplace 501 based on the title and PID, for example: http://www.themarketplace-service.com/my-listing-pd123 For every listing, there are two or more abstracted URLs on a different domain 502 and 503. One that the references the product itself 502 and the other which references the transactional link 504. Additionally, a secondary domain 506 may also be used to provide a URL 506 for the listing.

The Abstracted Product URL 508: http://swburl.com/p123 and Abstracted Transactional URL 509: http://swburl.com/b123 are shown which are used by a browser 507 and secondary URL application 512 to direct a view to the proper website locations. The abstracted product URL 508 redirects back to the listing's page on the marketplace 510. The abstracted transactional link 509 looks up the product's transactional link in the database and redirects the user to that link 511. This is extremely useful for syndication because not only does it “clean up” a very ugly and long transactional link but if the transactional link for the listing every changes on the marketplace, the syndicated links do not need updating. Flexible linking enablement links can also be abstracted since each instance of an flexible linking enablement player has a unique id: for example, Abstract Transactional URL for a given flexible linking enablement instance: http://swburl.com/f57

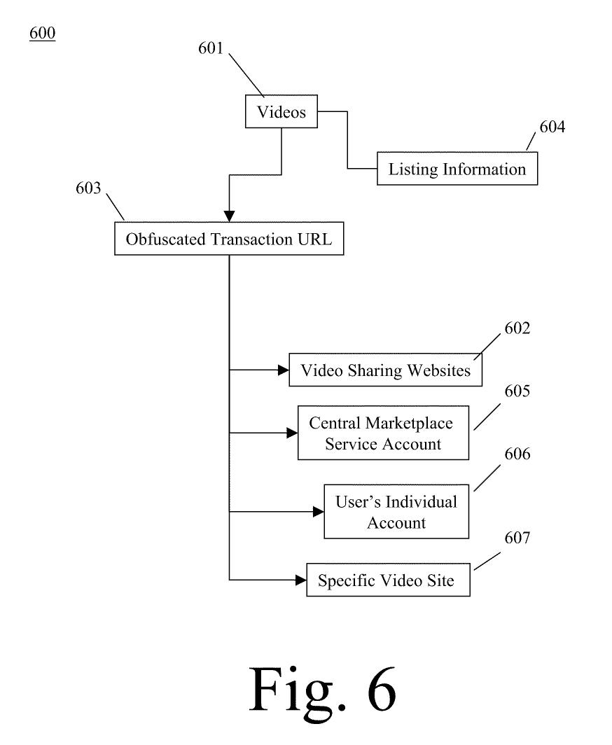

Now referring to FIG. 6, the Video Syndication process 600 is illustrated. Videos 601 are pushed to other video sharing sites 602 with an obfuscated Transactional URL 603 and other listing info 604 such as title, price, description, etc. Videos 601 can be syndicated to a central marketplace service account 605 or to a users own account 606 on a given video site 607 with their credentials. The syndication itself is not unique, but combining it with an obfuscated URL so that the link destination can be changed after posting is. By obfuscating the transactional URL on 3^{rd} party sited, only the marketplace URL needs to be updated.

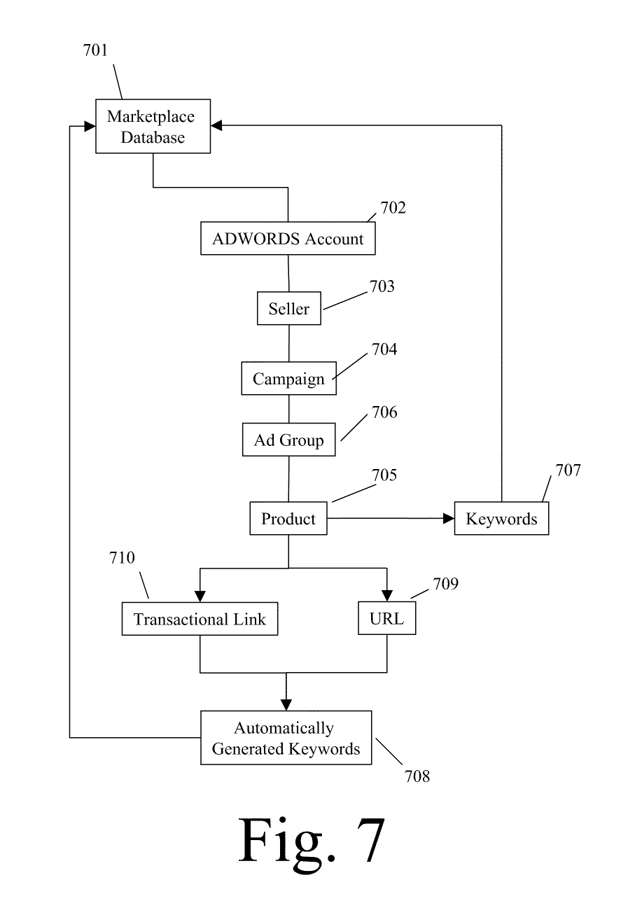

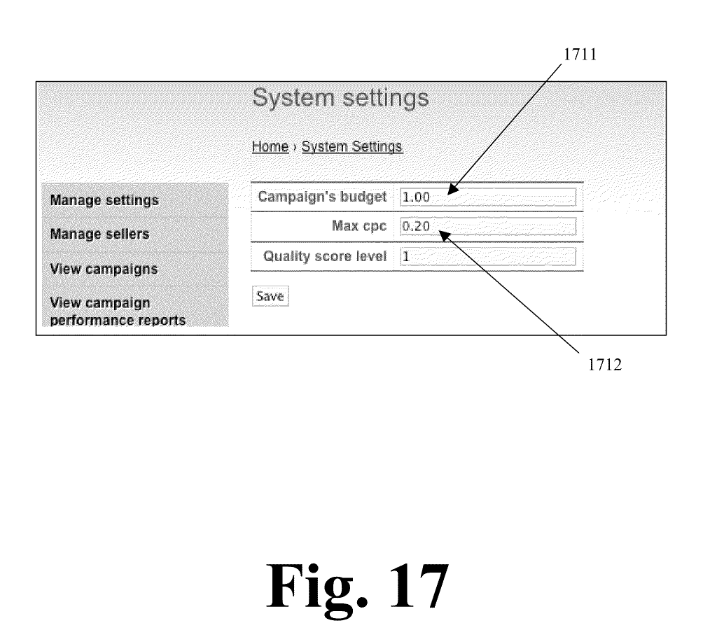

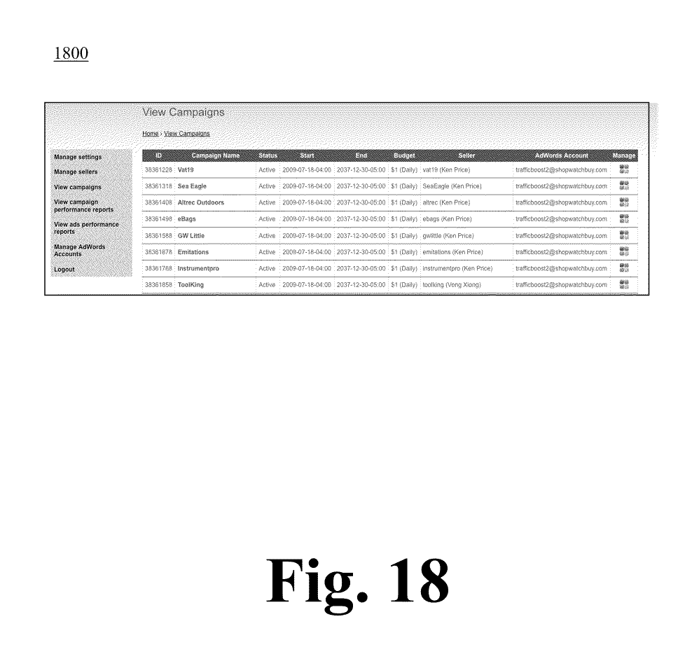

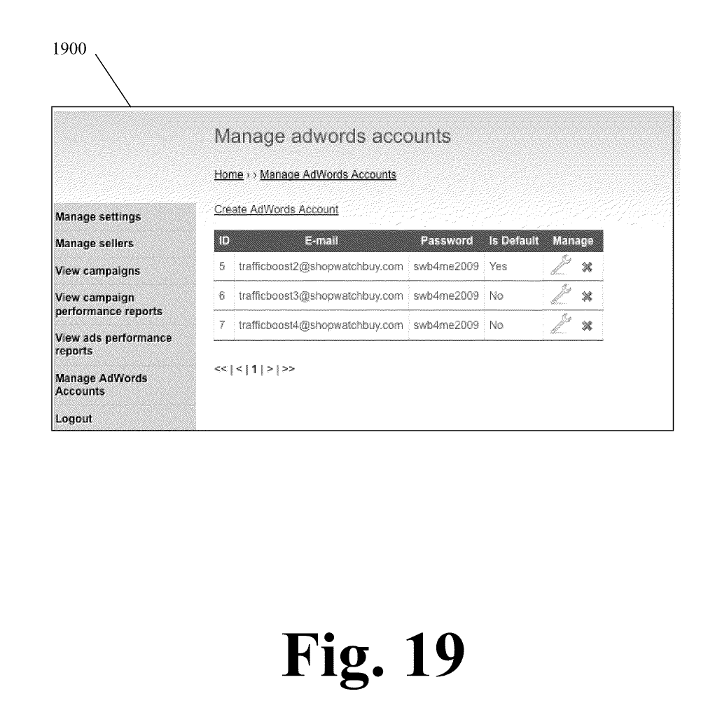

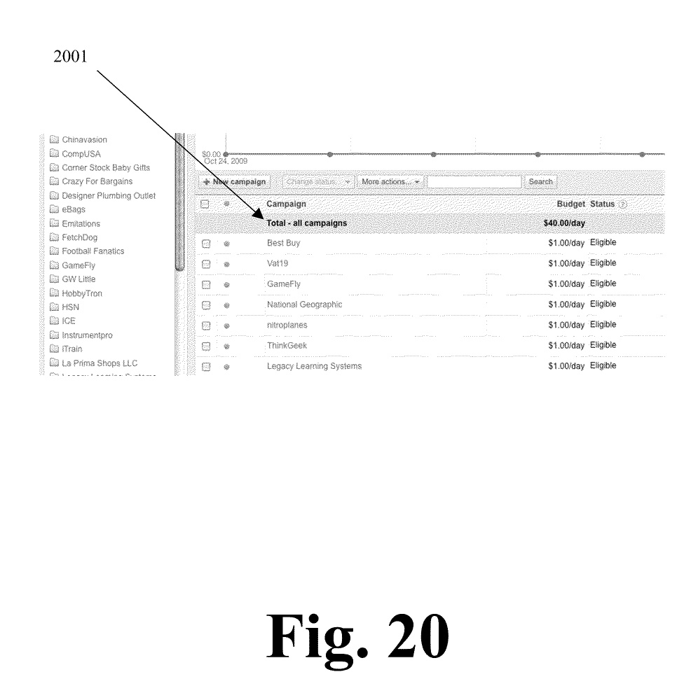

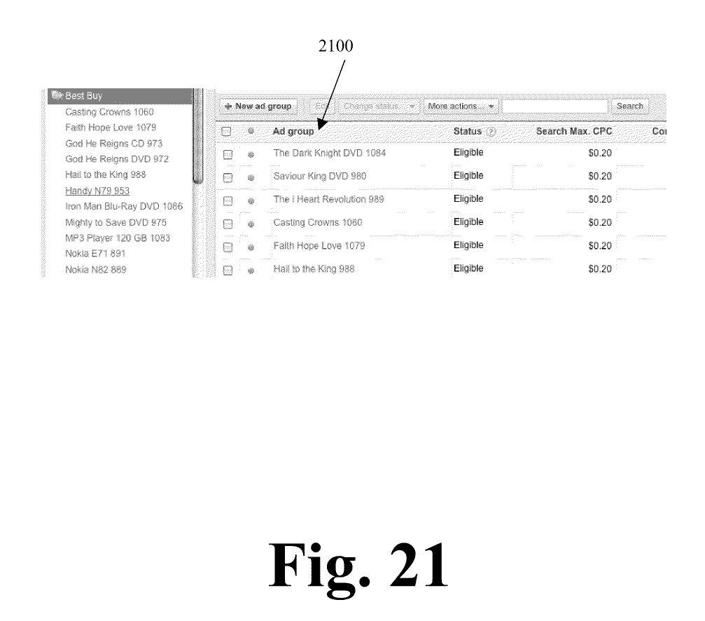

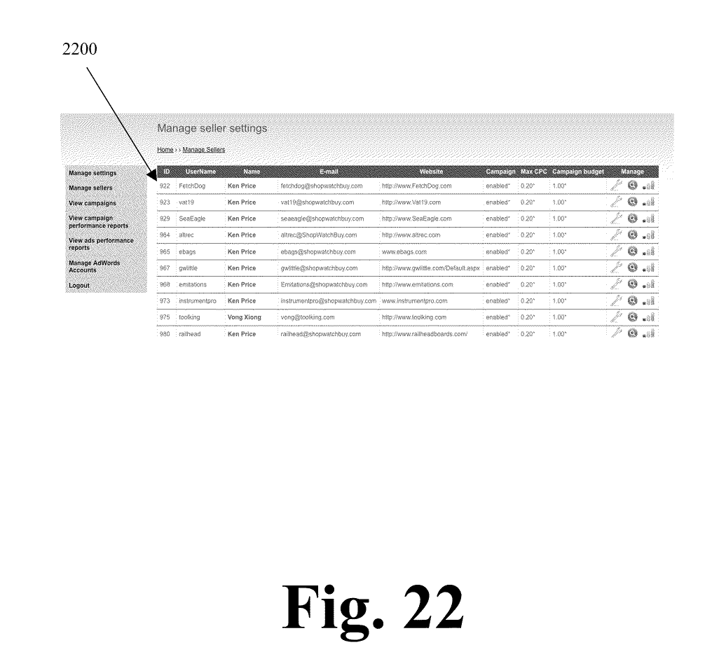

Now referring to FIG. 7, Ads are automatically generated based on the information from the listing contained in the marketplace database701. This is possible in part because of the format of the listing. In the ADWORDS Account 702 each seller 703 is mapped to one campaign 704 and each product 705 is in an ad group 706. Keywords 707 are based on the title, keyword field, brand, etc from the listing contained in the marketplace database701. Other keywords 708 are automatically generated based on the product URL 709 and the transactional link 710. A default budget 1711 and CPC 1712 as shown in FIG. 17 is set for all campaigns 2001 as shown in FIG. 20, but each campaign 1800 as shown in FIG. 18 (seller) can be adjusted individually or in groups 2101 as shown in FIG. 21. A seller can be individually made active or inactive. Groups of Sellers 2200 can be assigned to various ADWORDS accounts 1900 as shown in FIGS. 19-22. For example, the first one hundred sellers might be in ADWORDS account “A”, the second one hundred in account B, etc. The tracking ID's from ADWORDS are Stored in the database 701 for tracking, reporting and updating.

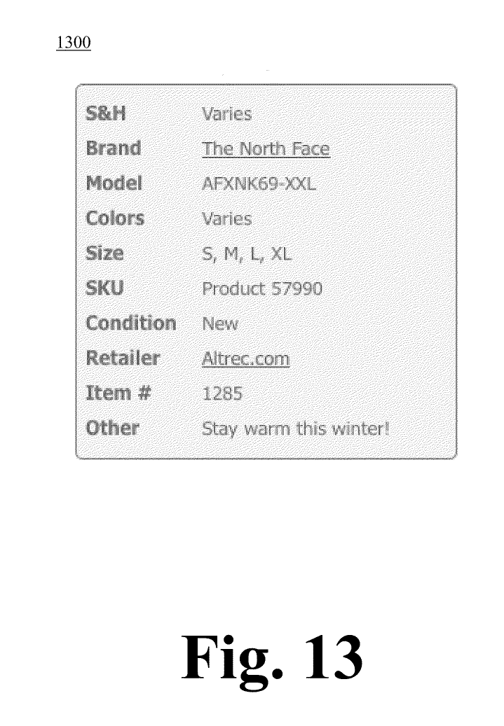

Metadata (data about data) is used as the structure of “what” to collect in a given listing. For example, a house might have metadata fields for bedrooms, bathrooms, stories, etc. . . . while a car would have year, make, model, etc. Video inherently only has limited metadata such as size, length, bit rate, etc. However, this metadata can be appended to include other information which is then used by search engines and applications to better understand the video content. When a user places a listing they select a listing “type” (product, housing, auto, etc.) each with a predefined metadata model to input data. Users can also select a “Custom” data model where in they specify both the metadata labels AND the corresponding data. In either case, the labels and data (name/value pairs) are appended to the video file as metadata tags. This metadata tagging of the video file with information from the listing makes the video file itself more “search engine friendly” as the metadata is visible and can be indexed by search engines. The metadata name/value pairs 1300 are also displayed on the marketplace for the user view info about the listing as shown in FIG. 13.

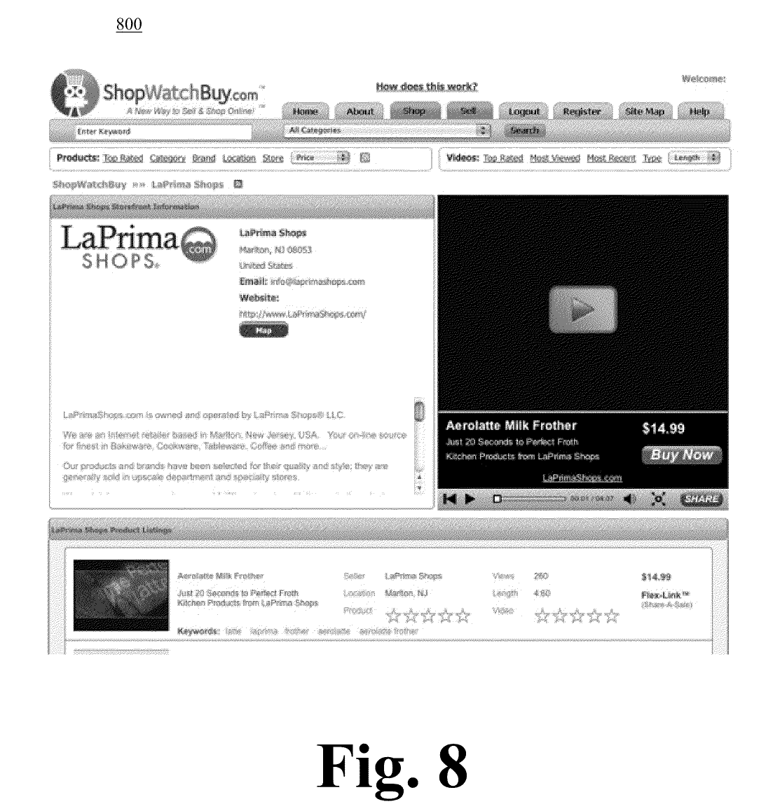

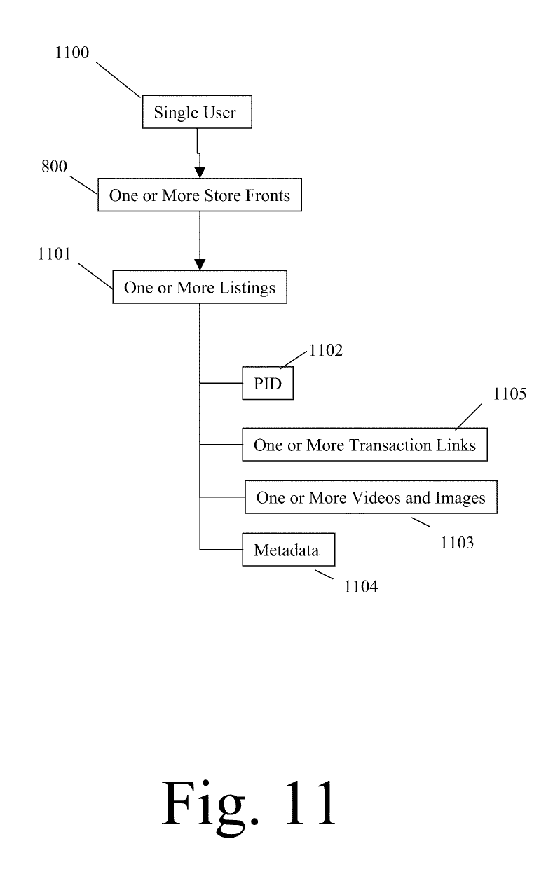

Sellers (users) can have one or more storefronts 800 as shown in FIGS. 8 and 11 with information about their business, a “default” video and their listings 1101. The storefront 800 is a child of the user entity, so a user can have more than one storefront 800. The product is a child of the storefront entity. The seller can use either use one of his or her video listings or upload an entirely unique video as the default listing for their Storefront 800.

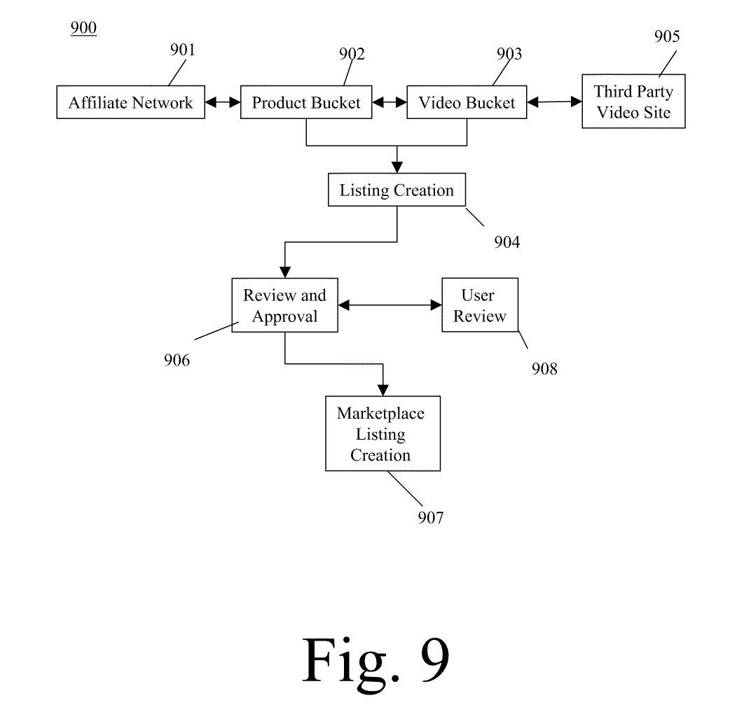

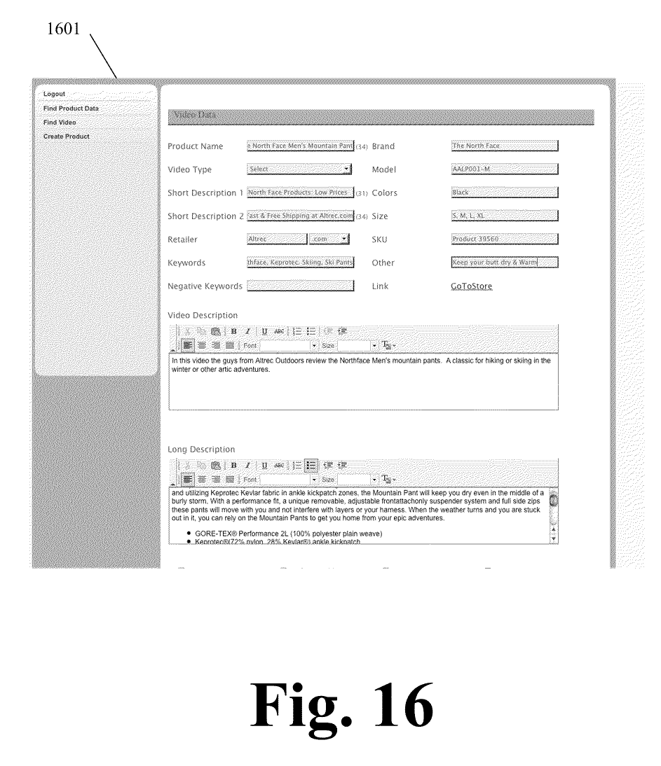

A Video & Product Data Entry System (also referred to as “DES”) 900, as shown in FIG. 9 allows the system to match up product data from an external source such as an affiliate network 901 (i.e. COMMISION JUNCTION) and an external, third party video site 905 (i.e. YOUTUBE). There's a “Video Bucket” 902 and “Product Bucket” 903 when the two buckets are matched, the DES user can “Create a Listing” 904. DES users select “create listing” 904 and move the screen to enter/edit more info 908. FIG. 16 shows an illustrative DES website page wherein a user can create a listing 1601 and provide product and video data to the system. Upon submitting the listing, it is sent to a queue for review and approval 906. Once approved, a listing is created on the marketplace 907. Instead of uploading a video direct from the DES users local computer, the video file is transferred, transcoded (optional) and put into a staging area for the DES Administration user to finalize the “create a listing” process. Alternatively, the video may not be transferred at all, but called into the video widget directly from a 3^{rd} party video site such as YOUTUBE. In this embodiment, the third party API is used to make a call and load the video into our own video player directly from the third party. In this embodiment the video no longer resides in our cloud and the DB pointer is to the third party video id instead of our own URL.

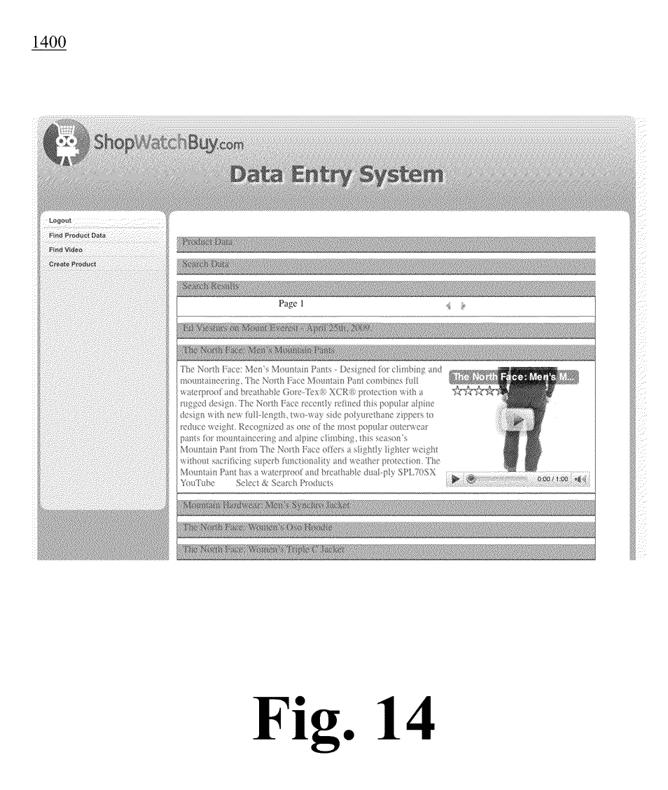

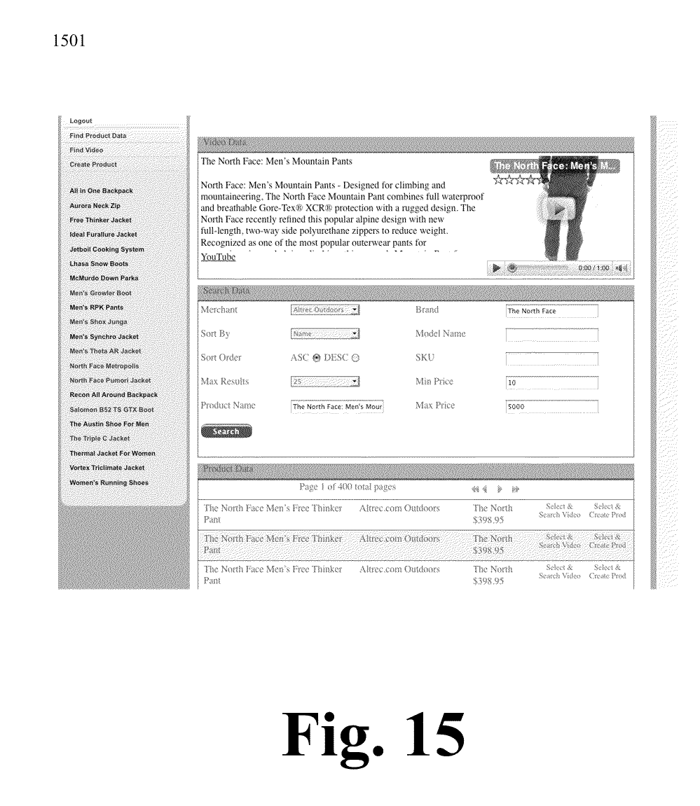

Users search for video (or product) based on a keyword, retailer, or 3^{rd} party video “channel name”. FIG. 14 shows an illustrative DES website page 1400 wherein a user is provided with video search results 1401. Alternatively, Users can select the video and then search for a product to match it (or vice versa). FIG. 15 shows an illustrative DES product search page with video selected 1501.

IPHONE redirection after syndication, currently the IPHONE does not play flash videos. However, through a partnership with YOUTUBE, the IPHONE can play YOUTUBE videos. If a video has been posted to the marketplace and then syndicated, the present invention stores the YOUTUBE video id in the database. If an IPHONE user comes to the marketplace, and the present invention have the YOUTUBE id, the user is automatically redirected from the marketplace to YOUTUBE to watch the video. In this way, if an IPHONE user searches for an item via a search engine and selects a marketplace result, they user will be able to view the listing's video.

IPHONE or other “smart phone” application for shoppers, a shopper will be able to search for products listing on the marketplace based on a variety of criteria base on the listing, seller and/or video. When selected, the user will be able to view more info about the product and/or watch the video. Depending on the format, the video may be fed to the device from the marketplace, or the shopper is redirected to a 3^{rd} party site to view (see redirection above).

IPHONE or other “smart phone” application for sellers, a seller will use the smart phone to shoot the video. Upon submission, the video is sent to the marketplace, transcoded (if needed) and place in the video staging area waiting for the user to create a listing from it.

A portable digital camera is embedded with software specific to the marketplace. The software not only allows the user to edit the video, but to also select a listing type, enter the necessary metadata, descriptions for the listing. In this way, the user never has to visit the website directly via a browser to create an active listing.

The Seller uploads product data in a programmatic fashion such a flat file, XML or series of web service calls. These products/listings may or may not have an actual video file (or video file pointer). The product data is then held in a queue as “listings that need a video”. The queue list can be viewed privately (by Seller) or publicly (by visitors to the marketplace). The seller and/or the user selects one of the listed products to match/add a video to and ultimately create a listing.

Videos are automatically transcribed via Speech-to-Text software. The transcription is added to listing's page and becomes part of the video's metadata.

Sellers can have and advertise on the marketplace a live video feed that is broadcast at a predetermined time (i.e. Monday at 1 PM EST). These live feeds can be on the Sellers own schedule and/or part of the Marketplace broadcast schedule. Live feeds have synchronized video and product data. That is, as the seller is describing a product, they can also input data for that product at the same time. As changes are made to the product on the Seller's end, they are reflected in the shopper's end.

Centralized schedule(s) for a page on the marketplace that broadcasts a live feed with timeslots for a given Seller at a given time. Broadcast Schedules can be organized in variety ways: Listing Type (Products, Cars, Houses, etc. . . . ); Location (County, State, City, etc. . . . ); Video type (reviews, demos, etc. . . . ). Sellers vie for a place on the central schedule either on a “first come, first serve” basis or based on payment for a preferred time slot. When a Seller's time slot arrives, the content for the central marketplace feed is substituted with the feed from their storefront channel.

During a live feed a Seller can put an item up for “auction” in real time. The auction and can a “Current Price” and a “Buy Now” price. If one item, the “Buy Now” price ends the auction, if more than one, then the shopper simply buys the item at that price. Shoppers enter the “current price” on what they are willing to pay at that moment and it is updated in real time. The bidder of the highest “current price” wins the item

Streaming videos (videos stored and played back for later) typically have comments left “after the fact” (i.e. a user watch the video and leave a comment). Real time videos need real-time comments. User logs in to the marketplace and selects the live video feed to view. As the video feed progresses users, both the presenter (seller) and viewer (shopper) are able to enter comments and interact via instant messaging. The presenter (seller) can kick off any user that is disruptive, vulgar, etc. The presenter can permanently ban any user from participating in the chat for his or her live feeds. When a user list their product on The marketplace service.com a user gets lots of exposure: Marketplace: Search Engine Optimized Listing on The marketplace service; Embed: Place their transactional video widget on their own website; Sharing: Using social media their video AND link can get viral; ADWORDS: The present invention automatically create ads for their products; Syndication: the present invention pushes their video to leading video sites; GOOGLE: automatically insert their product into the GOOGLE Database.

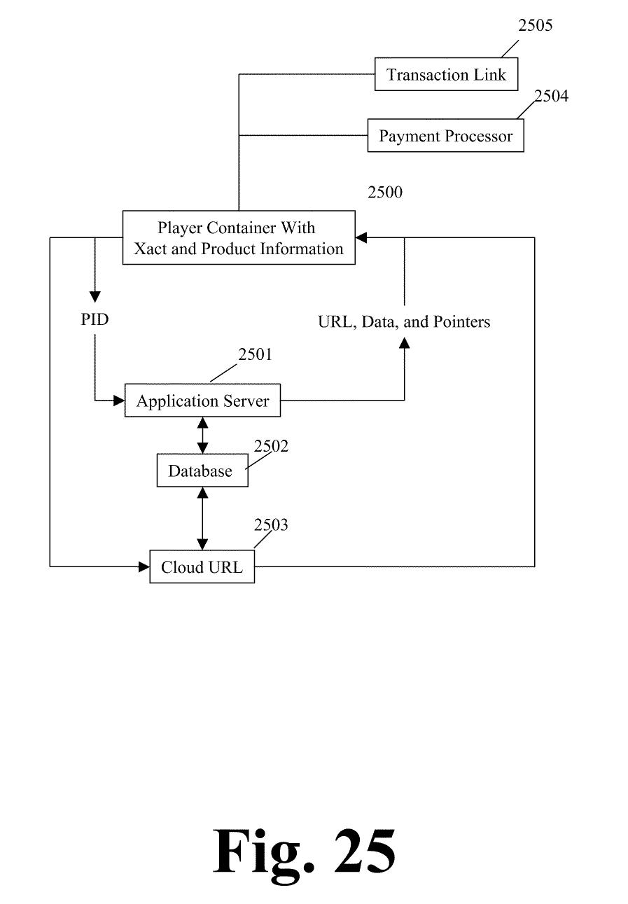

Now referring to FIG. 25, the video player consists of a player container 2500, application server 2501, database 2502, cloud URL 2503, and payment processor 2504. The player container 2500 is a flash or equivalent player that includes a video, link, and product information. The player container 2500 generates a PID and sends it to the Application server 2501 for approval. The application server searches for the PID in the database 2502. The Application server 2501 then generates the URL, data, and pointers and send them back to the player container 2500. The cloud URL 2503 then obtains the files including video, documentation and downloads from the player container 2500 and returns to the player container 2500 a combination of video and other complementary files. Finally, either “in player” payment 2504 is enabled and/or a transactional link 2505 is provided.

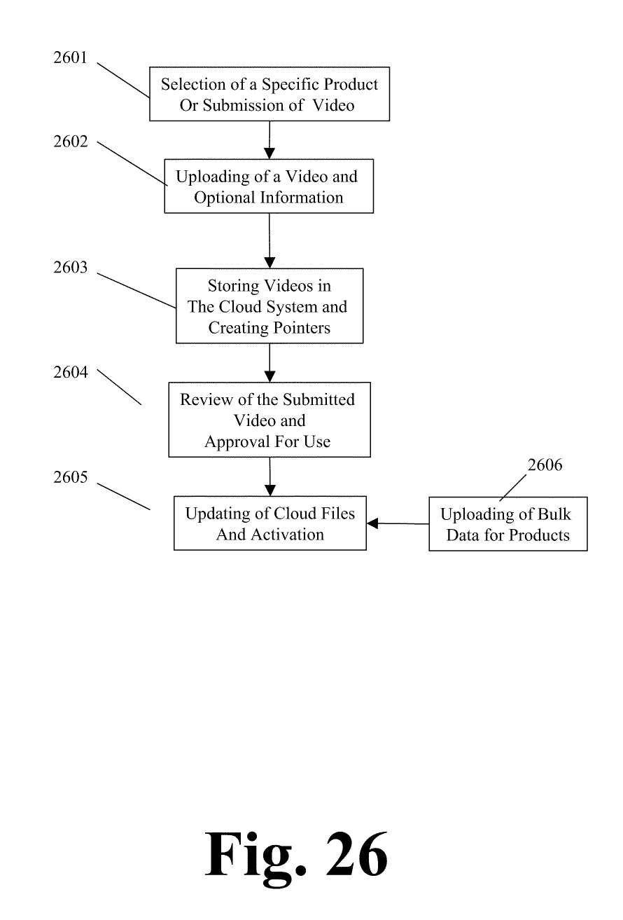

FIG. 26 provides a flow chart detailing the video workflow, which provides means for merchants and users to collaborate on product videos. In step 2601 a first user selects a specific product or just a “submit video” button in the market place 2600. This first user then uploads in step 2602 the videos and option information to the market place 2600. In step 2603 the videos are stored in the cloud system and pointers are created and stored in the database. In step 2604, a second user, the merchant/seller, reviews the submitted video and approves its use. Then, in step 2605 the cloud files are updated, changed, and the status becomes active, which is reported back to the market place 2600. Additionally, a merchant may upload bulk data for products needing videos in step 2606.

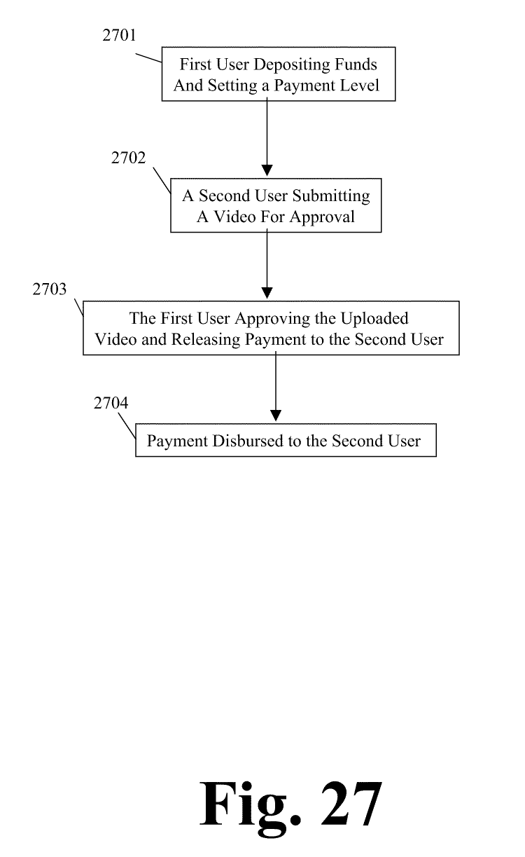

FIG. 27 illustrates the video work flow payment taught by the present invention. A first user deposits fund and sets a payment level(s) for approved video submissions 2701 A second user submits a video to the market place for approval. The first user 2702 approves the uploaded video and releases payment to the second user. Payment can be in real time or accumulated. If accumulated, the market place pays a user once per pre-determined period of time, for example monthly, for their contributions.

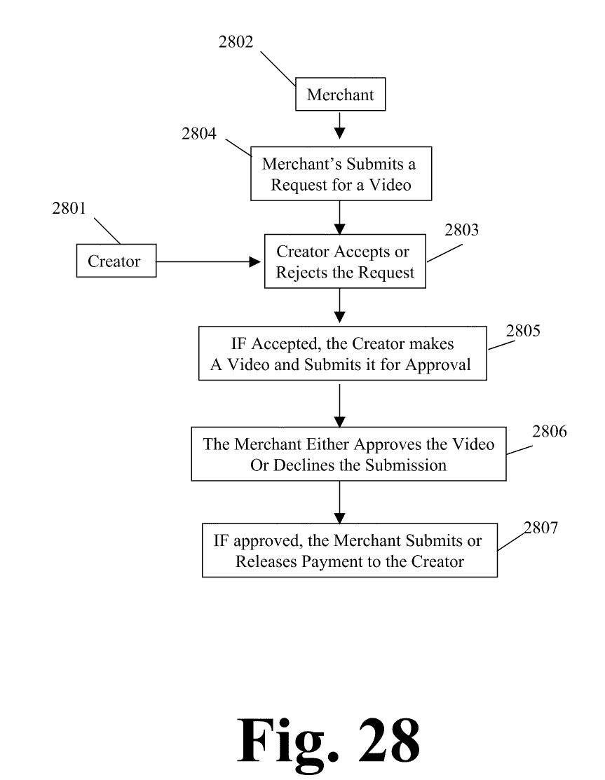

In FIG. 28, the video submission request occurs when a user generates videos, which are tracked, in response to a merchant's 2802 request for a video 2804. A first user, known as a video creator 2801 can either accept or reject requests 2803 from a merchant 2802 to create a video. If accepted, the first user 2801 creates a video and submits it for approval to the market place 2805. If the merchant 2802 approves the video 2806, they submit or release payment 2807 to the video creator 2801.

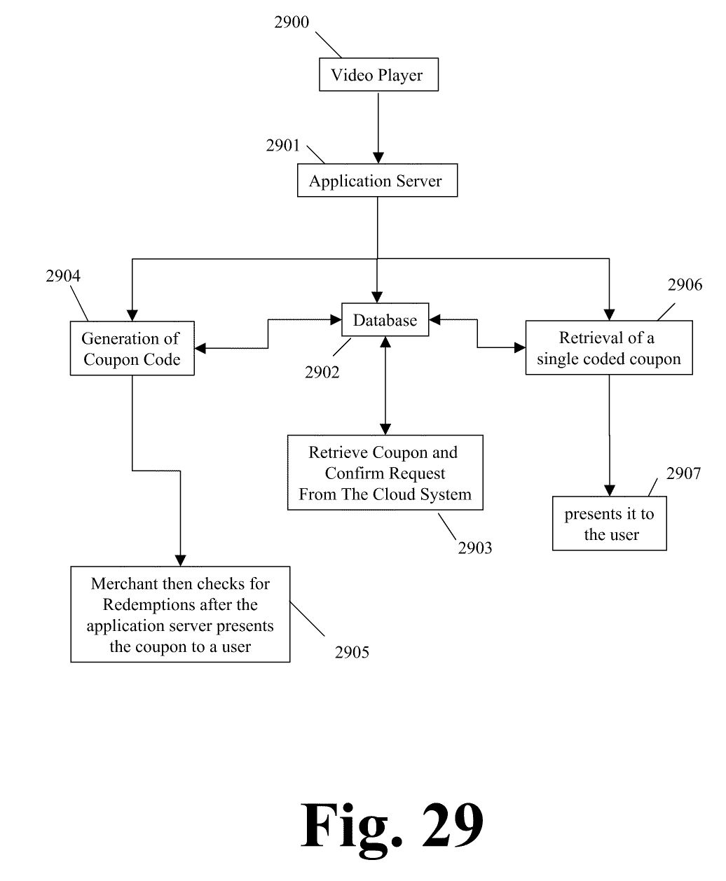

The present invention also teaches the use of video coupons with come in three embodiments. A video coupon, as described in FIG. 29 is controlled by the video player 2900. The first method requires the application server 2901 to access the database 2902 to retrieve coupons and confirm the requests from the cloud file system 2903. This first method results in downloadable coupons that use print outs, which are then redeemed in person or in a physical manner. In a second method, the video player 2900 requires access to the application server 2901, which generates a coupon code 2904 that is stored in the database 2902. A seller or merchant must then check for redemptions after the application server 2901 presents the coupon to a user 2905. This results in a single use coupon that is generated by the system that can then be tracked for usage by the seller or merchant. In a final method, the video player 2900 requires access to the application server 2901, which retrieves a single coded coupon 2906 that is stored in the database 2902 and presents it to the user 2907. This results in a generic or repeated use coupon with a single code for tracking purposes. Sellers can track single code coupons by entering a code as another piece of meta-data in the product listing. The code is then displayed at the end of the video or at another location in the video player 2900.

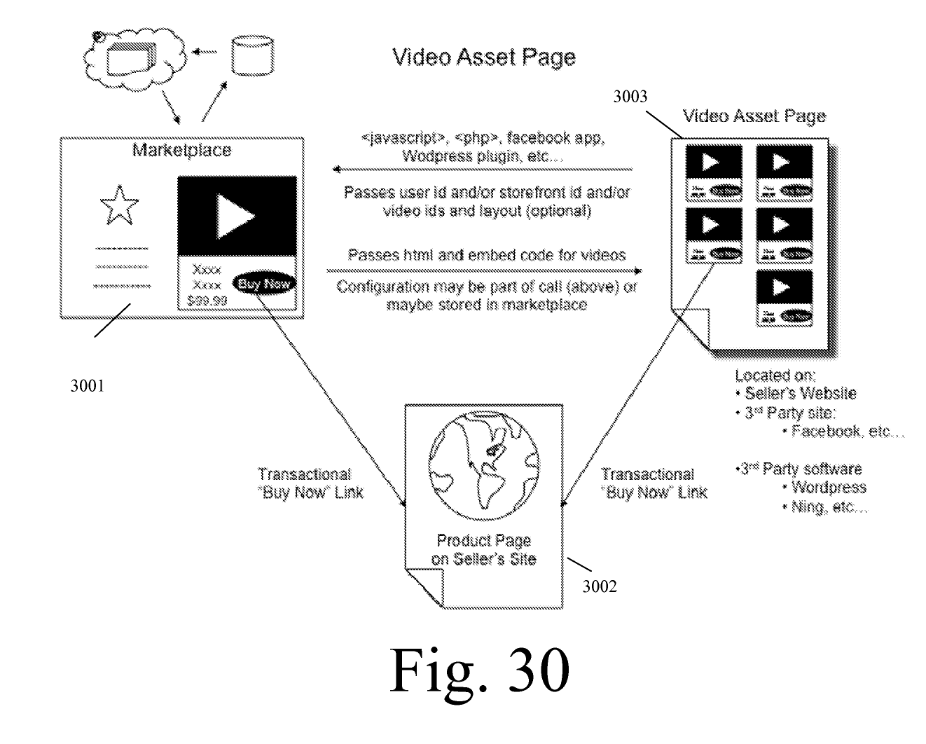

A Video Asset Page is show in FIG. 30. This feature pulls in videos from the marketplace for a given user (seller, merchant, etc. . . . ) to a page on their own website, 3rd party site (i.e. FACEBOOK) or 3rd party software (i.e. WORDPRESSBLOG plug-in) based on their user id and/or storefront and/or a partial list of listings (i.e. the user has 50 videos but selects only 20 to be pulled into their video asset page). This differs from typical video embedding that handles only one video at a time. Also, it is not just a page on the main video site (i.e. a “YOUTUBE Channel”). In step 3001 one or more Users upload one or more videos to the marketplace. In step 3002 Videos are available on the marketplace listing and on the user's “storefront” page. In step 3003, a Merchant logs in to marketplace and configures their “video asset page” for use elsewhere. This could include: Number of Videos or specific videos to include, Size of Video players, or Layout parameters such as Tile, List, Page Width. Depending on the destination, the user is presented with code or mechanism for placing on own site. Some examples include: Website—<javascript>, <html>; Facebook—integration via a “Facebook App” for a Video Page; and Wordpress—a plug-in that calls the video asset page from the marketplace. The transactional “Buy Now” links from the videos on the Video Asset page are the same as the links on the marketplace. This means an internet user on the merchants video asset page would not have to leave the merchant's website to watch the videos, or go to the product detail page.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A computer readable medium having computer executable instructions, that when executed by a computer causes the computer to perform a method for providing an online video advertising platform and marketplace comprising:
providing a computer system;
executing the method stored on computer readable medium by a computer acting as a web application server;
providing a database on the computer system;
providing a cloud computing file storage system;
proving multi-user access to the computer system;
accessing the computer system via a browser;
enabling one or more users to access the web application server, which, in turn, can access the database and cloud computing file storage system;
creating new users results in both an entry in the database and file structure with the username or other unique identifier in the file system;
storing the files in a predetermined convention accessing the files via an http call to a unique URL;
storing pointers to the files in the database;
uploading videos by users to the computer system;
creating a listing for every uploaded video by a selling user;
creating a product link for every uploaded video by a selling user;
creating a personal link for each selling user;
providing a transaction enabled video player by the computer system;
creating a video enabled e-commerce marketplace where every listing has a video in a transaction enabled video player;
tying all listings to a central product listing Id and transaction links;
searching for videos by both video and product related metrics; and
tagging videos files themselves with product metadata.

2. The method of claim 1 further comprising:
displaying an exemplary search engine optimization video listing;
including a still image and product information displayed with a link in a first defined space of a video listing;
providing a second defined space displaying a transaction video player, the video, link, and additional detailed information; and
correlating the link to the video so that wherever the video is displayed, the link is correspondingly displayed as well.

3. The method of claim 2 further comprising:
accessing the database by the video player for information and pointers to relevant files in the cloud computing file storage platform;
creating a dynamic video player for each listing;
tying each instance of the video player back to a unique product identification number in the database;
fixing the unique listing/product Identification number in the database to a video and a selling user;
calling the database by the video player based on the product Identification number;
pulling all information about the listing into the video player; and
pulling information related to the selling user.

4. The method of claim 3 further comprising:
linking the video player to other extraneous files associated with the listing;
retrieving, by the video player, a list of other products from the seller;
loading video and/or other information into the player for viewing when a different product is selected;
providing one or more transactional links via a button displayed on the video player or separate text that a user can click on; and
displaying a coupon code at the end of the video play;
displaying a static code from an uploaded image, or
displaying a dynamic code that is generated and displayed in the player at the end of the video.

5. The method of claim 4 further comprising:
propagating any changes made to the listing on the database anyplace that the video is shared because each player instance is tied back to the listing's unique product identification number in the database.

6. The method of claim 4 further comprising:
supporting multiple videos for multiple listings; and
providing multiple links for multiple listings.

7. The method of claim 4 further comprising:
opening a transactional link within the video player itself; and
allowing a user to complete the purchase on the page where the video player is embedded.

8. The method of claim 1 further comprising:
uploading a video;
putting uploaded videos in a queue waiting to be transcoded;
transcoding the video;
selecting a listing type to determine the meta-data model and transaction buttons that will be associated with the listing and video;
entering meta-data about the listing video;
defining a transaction button;
defining a transaction link;
selecting both video type and product category;
submitting the video file;
creating a listing;
re-naming the submitted video to match the listing title;
moving the video file from the transcoded folder to the video folder in the file system;
injecting the video file with Metadata based on the listing information entered;
editing, deleting, or viewing a potential listing;
extracting images from the video file or uploading images from a user's local computer, or importing images from another URL;
re-processing image extraction based on user input;
storing inactive images with the listing;
displaying active images in the marketplace;
automatically renaming images based on the listing title for search engine optimization;
changing the order in which active images are displayed; and
creating a thumbnail image associated with each video.

9. The method of claim 8 further comprising:
creating an account by a selling user with a submit video button;
displaying a list of products for which the selling user needs videos;
submitting a video by a user to the selling user;
placing the uploaded video in the selling user's user-submitted queue;
reviewing the video and/or product data and reject, approve or edit as needed by the selling user;
creating a listing if the submitted video is approved by the selling user; and
providing compensation to a user for the submission of a video used by a selling user;

10. The method of claim 8 further comprising:
uploading a video from user's computer;
uploading a video from a third party video-sharing; or uploading a video recorded directly from a users mobile recording device.

11. The method of claim 8 further comprising:
entering a title, which meets the character titles of a third party website;
entering a short description for the video which meets the character titles of a third party website;
displaying the title and short description in the video player; and
automatically creating advertisements for use in various third party online adverting systems.

12. The method of claim 11 further comprising:
providing users with flexible linking to utilize an affiliate marketing channel to monetize their videos; and
providing a selling user a flexible transactional link for the video player that can be substituted by a given affiliate.

13. The method of claim 12 further comprising:
inserting a default transactional link acting as a flexible transaction link;
providing a predefined or custom affiliate network link;
flagging the flexible transaction link with a visual cue; and
selecting which listings have been embedded, the number of plays, clicks, the specific transactional link, and other information.

14. The method of claim 12 further comprising:
entering a unique identifier by an affiliate for a specific network;
displaying to the affiliate the flexible linking enablement icon for a listing they want to use;
selecting the flexible linking enablement icon;
displaying a flexible linking enablement page presents the affiliate with customization selections;
submitting the flexible link; and
replacing a selling user's link with the Affiliate's Id, if it is not a pre-defined or custom affiliate network link.

15. The method of claim 12 further comprising:
substituting any link for the transactional link.

16. The method of claim 12 further comprising:
providing a link in the player which takes the user back to the marketplace flexible linking enablement page for that product; or
providing a link in the player that opens a window in the player itself and prompts the Internet user for a login to the marketplace; and
making a web service call back to marketplace by the video player;
providing the proper flexible linking enablement code based on the Internet user credentials; and
displays the proper flexible linking enablement code back to the user.

17. The method of claim 12 further comprising:
providing every listing with a website page in the marketplace based on the title and PID, providing, for every listing, two or more abstracted URLs on a different domain;
providing a first abstracted URL that references the product itself; and
providing a second abstracted URL that references the transactional link;
providing a secondary domain to provide a URL for the listing to direct a viewer to the proper website locations;
redirecting the abstracted product URL back to the listing's page on the marketplace;
looking up the product's transactional link by the abstract transactional link in the database; and
redirecting a viewer to the product's transactional link.

18. The method of claim 17 further comprising:
pushing videos to other video sharing sites with an obfuscated Transactional URL and other listing information;
syndicating videos to a central marketplace service account or to a selling user's own account on a given video site with their credentials;
combining the syndication of videos with an obfuscated URL so that the link destination can be changed after posting by obfuscating the transactional URL on a third party site; and
updating only the marketplace URL.

19. The method of claim 18 further comprising:
providing redirection after syndication;
storing a video that has been posted to the marketplace and then syndicated, with a third party video id in the database;
searching for products listing on the marketplace based on a variety of criteria base on the listing, seller and/or video;
automatically redirecting a user or viewer from the marketplace to a third party video displayer to watch the video.

20. The method of claim 1 further comprising:
advertising on the marketplace a live video feed that is broadcast at a predetermined time;
providing synchronized video and product data for the live video feed;
offering an item up for “auction” in real time;
displaying a current price and a buy now price;
submission of a current price bid buy a buying user on what they are willing to pay at that moment;
updating the current price in real time;
entering comments as the video feed progresses by users and interact via instant messaging; and
displaying comments and instant messaging with the video fee as it plays.

21. The method of claim 1 further wherein the video player consists of a player container;
application server;
database;
cloud URL;
payment processor;
the player container generates a product identification and sends it to the Application server for approval;
the application server searches for the product identification in the database;
the Application server then generates the URL, data, and pointers and send them back to the player container;
the cloud URL then obtains the files including video, documentation and downloads from the player container and returns to the player container a combination of video and other complementary files; and
either in player payment is enabled and/or a transactional link is provided.

22. The method of claim 1 further comprising:
access the database by the application server to retrieve coupons;
confirming the request from the cloud file system;
displaying a downloadable coupon that is printed outs and then redeemed in person or in a physical manner.

23. The method of claim 1 further comprising:
accessing the application server by the video player;
generating a coupon code by the application server that is stored in the database; and
checking for redemptions after the application server presents the coupon to a user.

24. The method of claim 1 further comprising:
accessing the application server by the video player;
retrieving a single coded coupon that is stored in the database; and
presenting the single coded coupon to a user at the end of the video or at another location in the video player.
